(19) United States
(12) Patent Application Publication
(10) Pub. No.: US 2025/0381084 A1
(43) Pub. Date: Dec. 18, 2025

(54) DEVICE FOR REDUCING VIBRATION IN NEONATAL TRANSPORTATION

(71) Applicant: Orlando Health, Inc., Orlando, FL (US)

(72) Inventors: Matthew SOLAR, Orlando, FL (US); Derek Benjamin Huss, Orlando, FL (US); Anthony Michael Mango, Orlando, FL (US); Julie Lachowitzer, Longwood, FL (US); Linda Lowman, Altamonte Springs, FL (US); Sankara Harinie Jeyabalan, Winter Park, FL (US)

(73) Assignee: Orlando Health, Inc., Orlando, FL (US)

(21) Appl. No.: 19/240,648

(22) Filed: Jun. 17, 2025

Related U.S. Application Data
(60) Provisional application No. 63/661,169, filed on Jun. 18, 2024.

(51) Int. Cl. A61G 11/00

(52) U.S. Cl. CPC A61G 11/00

(57) ABSTRACT

A device for providing neonatal transport vibration reduction. The device includes an upper plank, a lower plank, and a plurality of spring assemblies disposed between the upper plank and the lower plank. The upper plank includes a strap assembly configured to secure a baby on the upper plank. The lower plank is configured to releasably couple to a neonatal isolette.

### CROSS-REFERENCE TO RELATED APPLICATIONS

This application claims priority from U.S. Provisional Application No. 63/661,169, filed Jun. 18, 2024, which is hereby fully incorporated by reference herein in its entirety.

### TECHNICAL FIELD

The present disclosure relates generally to a device/method for reducing neonatal vibrations during transport.

### BACKGROUND

Neonatal transport processes and outcomes will be improved by decreasing vibration to neonates/infants on ground and air transports. Ideally the vibration reduction device can fit within or adapt to existing isolettes and equipment, allow the maximum workspace around neonates/infants, accommodate various sizes and weights of neonates/infants, and ensure neonates/infants are properly restrained inside isolettes.

### SUMMARY

One general aspect of the present disclosure includes a wire rope isolator, including a first end portion; a second end portion, where the first end portion and the second end portion substantially overlap each other in a first axis and are spaced apart from each other in the first axis; and a plurality of wire segments extending between the first end portion and the second end portion, where each wire segment includes a first end extending out of the first end portion and a second end extending out of the second end portion, where each wire segment of the plurality of wire segments crosses over at least one other wire segment of the plurality of wire segments to form a first X-shaped configuration when viewed from a point in a first plane.

Another general aspect of the present disclosure includes a device for providing neonatal transport vibration reduction, including: an upper plank configured to support a neonatal mattress; a lower plank configured to couple to a neonatal isolette; and a plurality of spring assemblies disposed between the upper plank and the lower plank, where each spring assembly of the plurality of spring assemblies provides a substantially uniform spring rate in a plurality of directions in a first plane that is substantially horizontal to the upper plank and the lower plank.

Another general aspect of the present disclosure includes a device for providing neonatal transport vibration reduction, including: an upper plank; a lower plank; and a plurality of spring assemblies disposed between the upper plank and the lower plank, where the upper plank includes a strap assembly configured to secure a baby on the upper plank, and where the lower plank is configured to releasably couple to a neonatal isolette.

A device according to the present disclosure may include any combination of the features described above and/or the original as-filed claims.

Other systems, methods, features and advantages of the invention will be, or will become, apparent to one with skill in the art upon examination of the following figures and detailed description. It is intended that all such additional systems, methods, features and advantages be within the scope of the invention.

### BRIEF DESCRIPTION OF DRAWINGS

FIG. 1 is a perspective view of an embodiment of a device for providing neonatal transport vibration reduction, including an upper plank, a lower plank, and a plurality of spring assemblies (e.g., wire rope isolators) disposed therebetween.

FIG. 2 is an exploded view of the device of FIG. 1.

FIG. 3 is an illustration showing the device in FIG. 1 with a neonate and a mattress disposed on the device.

FIG. 4 is an illustration of a conventional isolette, including an upper tray and a lower tray.

FIG. 4A is an illustration of the isolette of FIG. 4, where the upper tray is used as the lower plank of an embodiment of a device for providing neonatal transport vibration reduction.

FIG. 5 is an illustration of an isolette, showing the device of FIG. 1 is placed on the lower tray of the isolette.

FIG. 6 is an illustration of the isolette of FIG. 5, showing a neonate is secured on the device of FIG. 1.

FIG. 7 is a perspective view of an embodiment of a wire rope isolator.

FIG. 8 is an illustration of a lower plank of another embodiment of the device for providing neonatal transport vibration reduction, showing six wire rope isolators disposed thereon in a first configuration.

FIG. 9 is an illustration of a lower plank of another embodiment of the device for providing neonatal transport vibration reduction, showing seven wire rope isolators disposed thereon.

FIG. 10 is an illustration of a lower plank of another embodiment of the device for providing neonatal transport vibration reduction, showing four wire rope isolators disposed thereon.

FIG. 11 is an illustration of a lower plank of another embodiment of the device for providing neonatal transport vibration reduction, showing six wire rope isolators disposed thereon in a second configuration.

FIG. 12 is an illustration of a perspective view of another embodiment of a wire rope isolator including a cushion component.

FIG. 13 is an illustration of a perspective view of a portion of the wire rope isolator of FIG. 12, without the cushion component.

FIG. 14 is an illustration of another perspective view of a portion of the wire rope isolator of FIG. 12, without the cushion component.

FIG. 15 is an illustration of a perspective view of another embodiment of a wire rope isolator including a first cushion component.

FIG. 16 is an illustration of another perspective view of the wire rope isolator of FIG. 15, including a second cushion component.

FIG. 17 is an illustration of a perspective view of another embodiment of a device for providing neonatal transport vibration reduction, including an upper plank, a lower plank, and a plurality of spring assemblies (e.g., wire rope isolators) disposed therebetween.

FIG. 18 is an illustration of a top view of the device of FIG. 17.

FIG. 19 is an illustration of a cross-sectional view of the device of FIG. 17.

FIG. 20 shows two graphs illustrating the hysteresis effect between the displacement and the force on an embodiment of the wire rope isolator.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments disclosed herein, such as—for example—conventional fabrication and assembly.

### Generic Description

The invention is defined by the claims, may be embodied in many different forms, and should not be construed as limited to the embodiments set forth herein; rather, these embodiments are provided so that this disclosure will be thorough and complete, and will fully convey enabling disclosure to those skilled in the art. As used in this specification and the claims, the singular forms “a,” “an,” and “the” include plural referents unless the context clearly dictates otherwise. Reference herein to any industry standards (e.g., ASTM, ANSI, IEEE standards) is defined as complying with the currently published standards as of the original filing date of this disclosure concerning the units, measurements, and testing criteria communicated by those standards unless expressly otherwise defined herein.

The terms “about,” “substantially,” “generally,” and other terms of degree, when used with reference to any volume, dimension, proportion, or other quantitative or qualitative value, are intended to communicate a definite and identifiable value within the standard parameters that would be understood by one of skill in the art (e.g., equivalent to a mechanical engineer with experience in this field), and should be interpreted to include at least any legal equivalents, minor but functionally-insignificant variants, standard manufacturing tolerances, and including at least mathematically significant figures (although not required to be as broad as the largest range thereof), including a variance of up to, for example 10%, 5%, 2%, 1%, or less or more as would be deemed appropriate by one of skill in the art. In addition, the term “configured to” is used to describe structural limitations in a particular manner that requires specific construction to accomplish a stated function and/or to interface or interact with another component(s), and is not used to describe mere intended or theoretical uses.

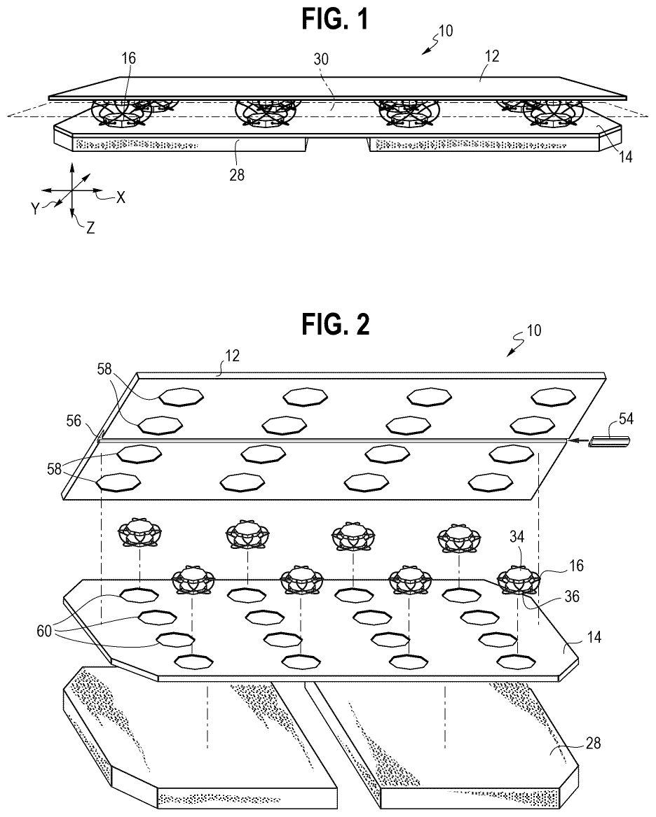

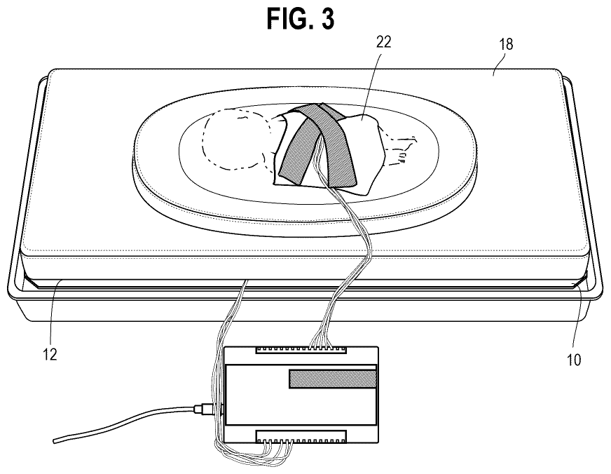

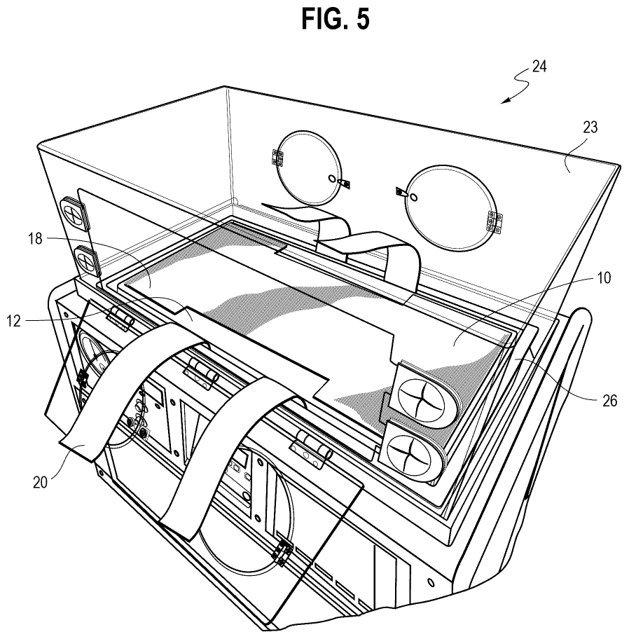

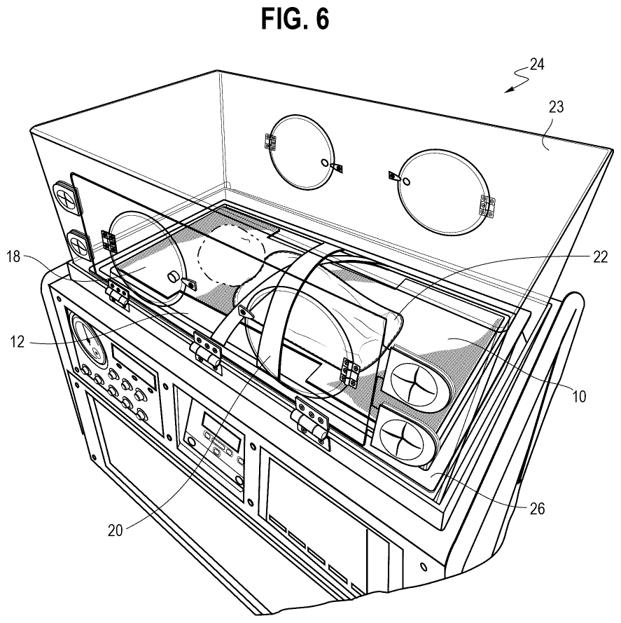

One embodiment of a device 10 for providing neonatal transport vibration reduction is described with reference to FIGS. 1-6. As shown in FIGS. 1 and 2, the device 10 includes an upper plank 12, a lower plank 14, and a plurality of spring assemblies 16 disposed between the upper plank 12 and the lower plank 14. As shown in FIG. 3, the upper plank 12 is configured to support a neonatal mattress 18 disposed on the upper plank 12. In some embodiments, as shown in FIGS. 1 and 2, the device 10 may optionally include a vibration-reduction layer 28 disposed underneath the lower plank 14. The vibration-reduction layer 28 is provided to dampen the vibration between the lower plank 14 and the structure disposed underneath the lower plank 14 (e.g., a lower tray 26 of a neonatal isolette 24; discussed below), and also compensate for any unevenness underneath the lower plank 14, allowing the device 10 to lie evenly, e.g., inside a neonatal isolette 24. The vibration-reduction layer 28 may be made of foam or any other materials configured to reduce high frequency resonant vibration.

In some embodiments, as shown in FIG. 2, one or more spines 54 may be provided under the upper plank 12 (e.g., under the middle of the upper plank 12) to reduce the bowing. The one or more spines 54 are configured to be rigid enough so that the upper plank 12 does not bow too much, but flexible enough to absorb the vibration. In some embodiments, as shown in FIG. 2, the one or more grooves 56 may be provided under the upper plank 12 (e.g., under the middle of the upper plank 12), such that depending on the weight of the baby, a user can slide different spine(s) 54 into the one or more grooves 56, thereby adjusting the spring rate of the upper plank 12 by the different configurations of the spine(s). The configuration (e.g., location, shape, number, thickness, length) of the one or more grooves 56 and the configuration (e.g., number, shape, thickness, length, material) of the one or more spines 54 may be varied, as desired and/or needed, without departing from the scope of the present invention.

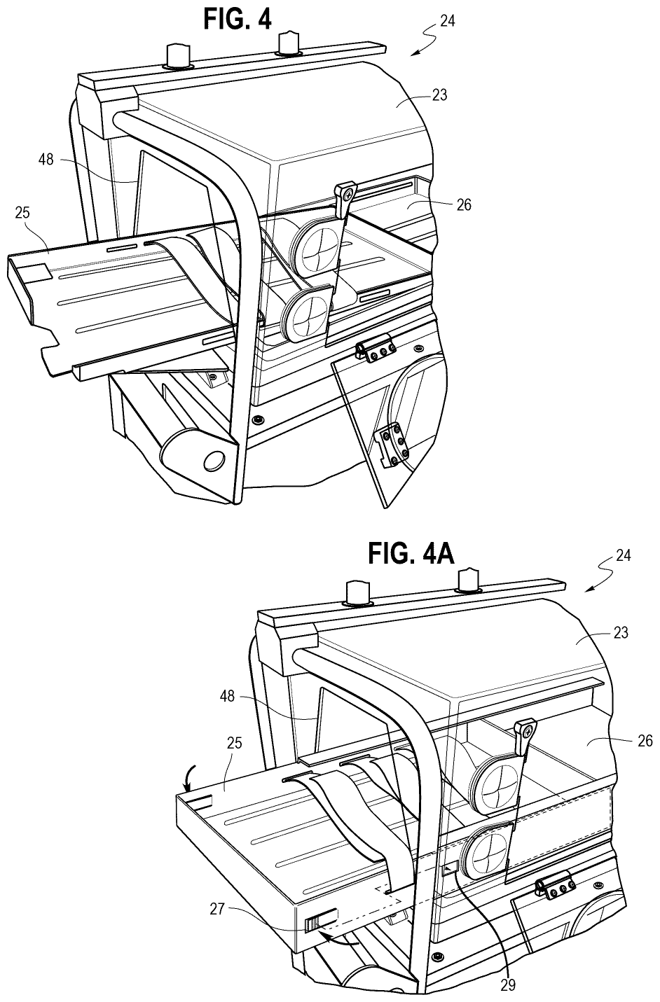

Referring to FIGS. 3-5, the upper plank 12 may include a strap assembly 20 configured to secure a baby 22 (e.g., neonate, infant) on the upper plank 12 (e.g., on the neonatal mattress 18 disposed on the upper plank 12). The lower plank 14 is configured to releasably couple to a neonatal isolette 24 (e.g., to a lower tray 26 of the neonatal isolette 24). As one non-limiting example, as shown in FIG. 4A, the upper tray 25 is releasably coupled to the lower tray 26 via a button 27 on the upper tray 25 and the slot 29 on the lower tray 26. Any suitable means may be used to couple the upper tray 25 and the lower tray 26 together, without departing from the scope of the present application.

As shown in FIG. 4, in a conventional neonatal isolette 24, an upper tray 25 is disposed on the lower tray 26, and the baby 22 will be secured on the upper tray 25 for transportation. In some embodiments, the device 10 is adapted to be used in a neonatal isolette 24, where the upper tray 25 may be replaced with the device 10, or the upper tray 25 may be used as the lower plank 14 of the device 10 (e.g., as shown in FIG. 4A). As shown in FIGS. 4-6, when the upper tray 25 is replaced with the device 10, similar to using the upper tray 25, a user may slide the device 10 into the chamber 23 of the neonatal isolette 24 such that the device 10 is locked with respect to the lower tray 26 via any suitable means (e.g., via similar mechanisms used to couple the upper tray 25 and the lower tray 26 together, as shown in FIG. 4A).

Replacing the upper tray 25 with the device 10 is advantageous for minimizing the overall height and leave more space above the baby inside the chamber 23. Also, it allows a user to have quick access to the baby 22 through the end (e.g., end 48 as shown in FIG. 4) of the chamber 23. In some embodiments, rollers may be provided on the bottom of the device 10, facilitating easy removal of the device 10 from the lower tray 26. In some embodiments, additional lock-down levers may be provided to hold the device 10 to the lower tray 26. In some embodiments, a handle may be provided on the end of the device 10 to facilitate removal.

In some embodiments, as shown in FIG. 2, the upper plank 12 may include a plurality of upper pockets 58 respectively configured to receive and releasably secure the plurality of spring assemblies 16 therein, and/or the lower plank 14 may include a plurality of lower pockets 60 respectively configured to receive and releasably secure the plurality of spring assemblies 16 therein. The configuration (e.g., shape, size) of the upper and lower pockets 58 and 60 may be varied, according to the configuration (e.g., shape, size) of the first end portion 34 and the second end portion 36 of the spring assembly 16 (discussed in greater detail below), without departing from the scope of the present invention, as long as the plurality of spring assemblies 16 may be secured therebetween. Having the spring assemblies 16 releasably coupled to the upper and lower planks 12 and 14 (e.g., via the upper and lower pockets 58 and 60) is advantageous for easily changing the number, spring rate, and pattern/arrangement of the plurality of spring assemblies 16, as needed and/or desired, based on the situation (e.g., baby weight, vibration level).

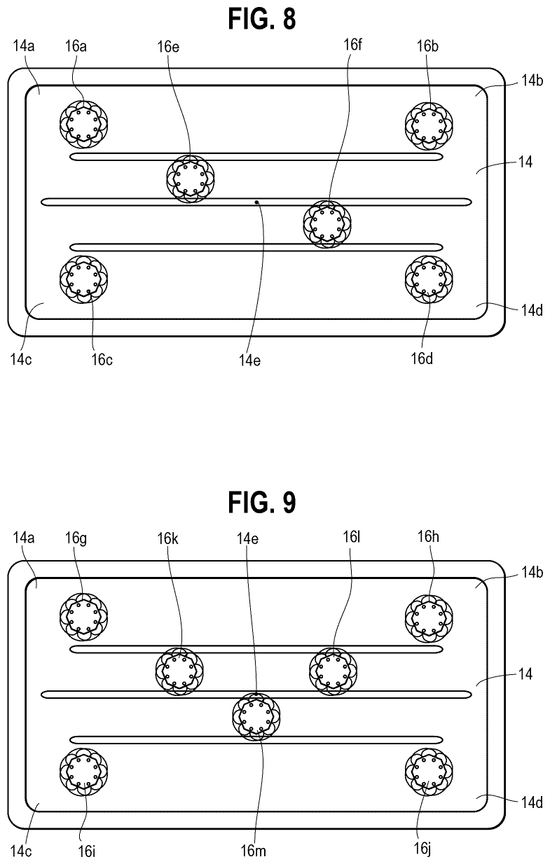

In some embodiments, the plurality of spring assemblies 16 may be releasably coupled to the upper plank 12 and the lower plank 14, via any suitable means (e.g., magnets). In some embodiments, the upper pockets 58 and lower pockets 60 may be configured such that a user may select a desired number of spring assemblies 16 with desired spring rate(s), and put them into selected upper and lower pockets 58 and 60 to achieve a desired arrangement/pattern of the plurality of spring assemblies 16 for a baby with a specific weight (as discussed below with reference to FIGS. 8-11). In some embodiments, the spring assemblies 16 with different spring rates may have different colors, thereby facilitating identifying the desired spring assembly with a desired spring rate easily.

Referring back to FIG. 1, the plurality of spring assemblies 16 is configured to decrease vibration for transporting a baby secured on the upper plank 12. In some embodiments, each spring assembly 16 of the plurality of spring assemblies provides a substantially uniform spring rate in a plurality of directions in X, Y, and Z directions (e.g., including providing a substantially uniform spring rate in a plurality of directions in a first plane 30 that is substantially horizontal to the upper plank 12 and the lower plank 14.)

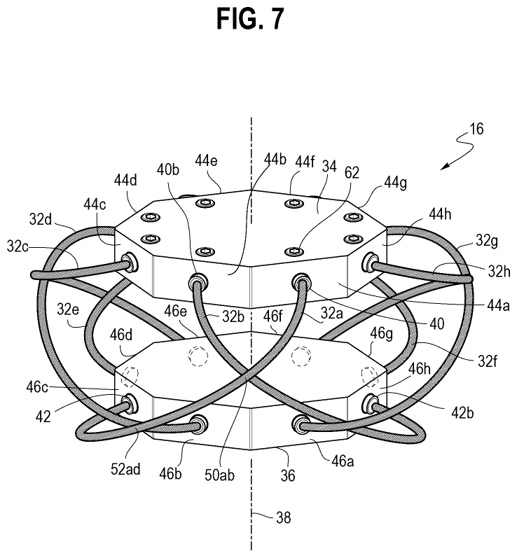

Referring to FIG. 7, in some embodiments, each spring assembly 16 of the plurality of spring assemblies is a wire rope isolator 16, which includes a plurality of wire segments 32. In some embodiments, each wire segment 32 of the plurality of wire segments is plastic coated, and is made of stainless-steel cable or solid plastic. The wire rope isolator 16 may include a first end portion 34 and a second end portion 36. The first end portion 34 and the second end portion 36 may substantially overlap each other in a first axis 38 and are spaced apart from each other in the first axis 38.

The wire rope isolator 16 also includes a plurality of wire segments 32 extending between the first end portion 34 and the second end portion 36. In some embodiments, as shown in FIG. 7, each wire segment 32 includes a first end 40 extending out of the first end portion 34 and a second end 42 extending out of the second end portion 36, where each wire segment 32 of the plurality of wire segments crosses over at least one other wire segment 32 of the plurality of wire segments to form a first X-shaped configuration 50 (e.g., formed by wire segments 32a and 32b) when viewed from a point in the first plane 30.

In some embodiments, each wire segment 32 of the plurality of wire segments crosses over at least two other wire segments 32 of the plurality of wire segments to form the first X-shaped configuration 50 (e.g., formed by wire segments 32a and 32b) and a second X-shaped configuration 52 (e.g., formed by wire segments 32a and 32d) when viewed from a point in the first plane 30. The first X-shaped configuration 50 may be closer to the first end portion 34 than the second X-shaped configuration 52, and the second X-shaped configuration 52 may be closer to the second end portion 36 than the first X-shaped configuration 50. In some embodiments, a plurality of X-shaped configurations may be uniformly formed by the plurality of wire segments 32 around the first axis 38, which is advantageous as the spring rate provided by the wire rope isolator 16 would be substantially independent from the X, Y, and Z directions, such that the wire rope isolator 16 will not need to be specifically oriented to provide the desired spring rate.

In some embodiments, the first end portion 34 may include a plurality of upper side facets 44 and the second end portion 36 may include a plurality of lower side facets 46. Each upper side facet 44 of the plurality of upper side facets may include a first end 40 of a wire segment 32 extending out of the respective upper side facet 44 in a direction substantially vertical with respect to the respective upper side facet 44. Each lower side facet 46 of the plurality of lower side facets may include a second end 42 of a wire segment 32 extending out of the respective lower side facet 46 in a direction substantially vertical with respect to the respective lower side facet 46. Having the wire segment 32 extend out of the respective side facet vertically is advantageous for providing a consistent performance of the wire rope isolator 16, such that rotating the wire rope isolator 16 would not affect the spring rate too much.

In some embodiments, as shown in FIG. 7, each wire segment 32 extends over at least one upper side facet 44 and at least one lower side facet 46 (e.g., the wire segment 32a is coupled to the upper side facet 44a and the lower side facet 46c, extending over the upper side facet 44b and the lower side facet 46b). It will be understood that the number of upper and lower side facets 44 and 46 crossed over by each wire segment 32 may be the same or different, and may be varied, as desired and/or needed, without departing from the scope of the present invention. In some embodiments, there is at least one set screw 62 in the first end portion 34 and/or the second end portion 36 to hold ends of the plurality of wire segments 32 within the first end portion 34 and the second end portion 36.

As one non-limiting example, as shown in FIG. 7, the wire rope isolator 16 includes eight wire segments 32 (32a-32h) extending between the first end portion 34 and the second end portion 36. The first end portion 34 includes eight upper side facets 44 (44a-44h), and the second end portion 36 includes eight lower side facets 46 (46a-46h). As shown, each of the eight upper side facets 44a-44h and each of the eight lower side facets 46a-46h are substantially aligned in the respective vertical directions that are substantially parallel with the first axis 38.

Using a few wire segments 32 as an example to illustrate the features discussed above. As shown in FIG. 7, the wire segment 32a includes a first end 40a and a second end 42a, and the wire segment 32b includes a first 40b and a second end 42b. The first end 40a extends out of the upper side facet 44a (e.g., in a direction substantially vertical with respect to the upper side facet 44a), and the second end 42a extends out of the lower side facet 46c (e.g., in a direction substantially vertical with respect to the lower side facet 46c). The first end 40b extends out of the upper side facet 44b (e.g., in a direction substantially vertical with respect to the upper side facet 44b), and the second end 42b extends out of the lower side facet 46h (e.g., in a direction substantially vertical with respect to the lower side facet 46h).

As shown in FIG. 7, the wire segment 32a crosses over the wire segment 32b, such that the wire segments 32a and 32b form a first X-shaped configuration 50ab. The wire segment 32a also crosses over the wire segment 32d, such that the wire segments 32a and 32d form a second X-shaped configuration 52ad. The first X-shaped configuration 50ab is closer to the first end portion 34 than the second X-shaped configuration 52ad, and the second X-shaped configuration 52ad is closer to the second end portion 36 than the first X-shaped configuration 50ab.

It will be understood that the configuration (e.g., shape, arrangement/relative positioning) of the first end portion 34 and the second end portion 36, the configuration (e.g., number, shape, arrangement/relative positioning) of the upper side facets 44 and the lower side facets 46, and the configuration (e.g., number, length, diameter, material, strength, arrangement) of the wire segments 32 may be varied as desired and/or needed, without departing from the scope of the present disclosure, as long as a substantially uniform spring rate in a plurality of directions, as needed/desired, is achieved. It will be understood that to achieve the desired small spring rate with a short length of the wire segment is desired so that the height of the device 10 is not enlarged too much, leaving sufficient space for the baby disposed on the device 10 while in the chamber 23 of a neonatal isolette 24.

For example, although the shape of the first end portion 34 and the second end portion 36 are shown as octagons, the configuration of the first end portion 34 and the second end portion 36 may be the same or different, may have any shape (e.g., circle, oval), and may include any number of side facets, as desired/needed, without departing from the scope of the present invention. In addition, although each upper side facet 44 and each lower side facet 46 includes one end of a wire segment 32 extending out thereof, it will be understood that each upper side facet 44 and each lower side facet 46 may include one or more ends of the wire segments extending out thereof, and the number of the ends of the wire segments 32 extending out of each upper side facet 44 and each lower side facet 46 may be the same or different, as desired and/or needed, without departing from the scope of the present invention.

Moreover, it will be understood that the number of wire segments 32 of each wire rope isolator 16 may be varied, as desired and/or needed, without departing from the scope of the present invention (e.g., 4, 8, 16, or more). It will be understood that the more wire segments 32 are used, the more uniform the dampening of the wire rope isolator 16 is. In other words, infinite wire segments approach uniform dampening in all coordinate planes (e.g., uniform spring rate in 360 degrees in multiple different planes).

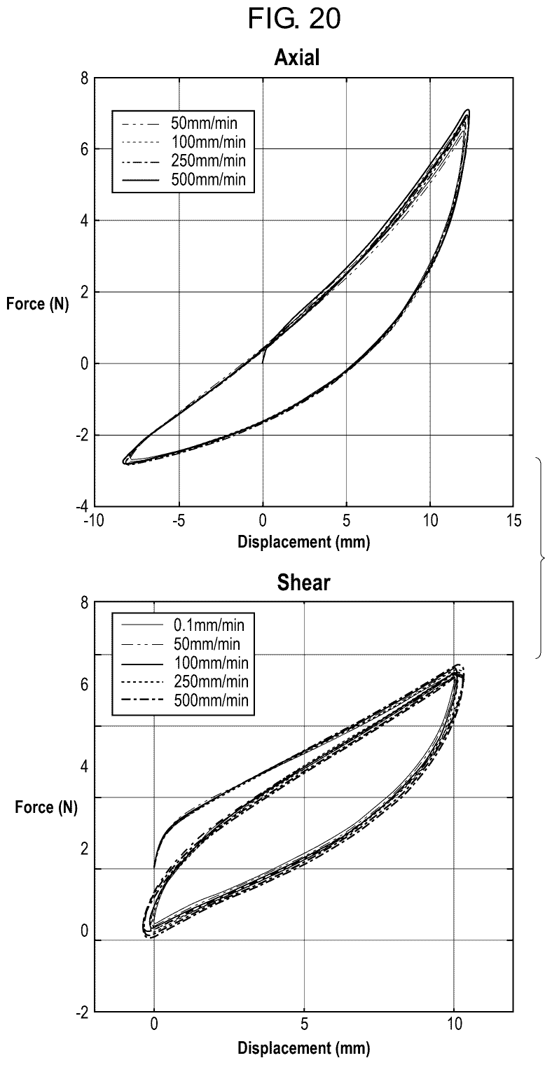

The wire rope isolators provide a hysteresis effect in their response to both axial and sheer loadings. For example, this hysteresis effect is illustrated in FIG. 20, where the relationship between the force and displacement of the wire rope isolator is non-linear and changes based on whether it is being displaced (flexing) or is returning from the displaced state (relaxing). As such, this hysteresis effect reduces an abrupt or sharp spring back motion and serves to dampen the subsequent vibrations of the wire rope isolators and the upper planks attached thereto. This hysteresis effect is present in a plurality of directions, e.g., including at least the X and Y directions (sheer vibration), and the Z direction (axial vibration) (e.g., as shown in FIG. 1). The hysteresis effect is also present across a wide range of vibration frequencies imparted on the wire rope isolators. This hysteresis effect is particularly advantageous for reducing or damping potentially harmful vibrations imparted on the neonate/infant on the neonatal isolette. For example, if the neonatal isolette turns fast or is jolted by a bump in the road (e.g., within an ambulance), the wire rope isolator 16 may shift left and/or right, forward and/or backward, and up and/or down. The hysteresis effect in each of these directions further dampens the vibration, which helps protect the neck, head, and other portions of the neonate/infant on the neonatal isolette.

Furthermore, the configuration (e.g., length, diameter) of each wire segment 32 of the plurality of wire segments 32 may be varied such that the spring rate of the wire rope isolator 16 may be varied, as desired and/or needed. As one non-limiting example, the wire rope isolator 16 may provide a spring rate ranging from about 1 to about 2 pounds/inch (e.g., 1.3 pounds/inch), where the diameter of each wire segment 32 may range between about 1 mm and about 2 mm (with a specific example at about 1.7 mm). As another non-limiting example, the wire rope isolator 16 may provide a spring rate ranging from about 5 to about 6 pounds/inch (e.g., 5.4 pounds/inch), where the diameter of each wire segment 32 may range between about 1.5 mm and about 4 mm. As another non-limiting example, the wire rope isolator 16 may provide a spring rate ranging from about 11 to about 12 pounds/inch (e.g., 11.7 pounds/inch), where the diameter of each wire segment 32 may range between about 2 mm and about 6 mm.

In addition, the number, type, and arrangement of the plurality of spring assemblies (e.g., wire rope isolators) 16 that are disposed between the upper plank 12 and the lower plank 14 may be varied, as desired and/or needed, without departing from the scope of the present invention, to provide a vibration reduction device 10 that is suitable for transportation of babies with different weights.

As one non-limiting example, as shown in FIG. 8, the plurality of spring assemblies 16 of a vibration reduction device 10 includes six spring assemblies 16a-16f, where each spring assembly of the plurality of spring assemblies provides a spring rate ranging from about 1 to about 2 pounds/inch. As shown, four spring assemblies 16a-16d of the plurality of spring assemblies are disposed at four corners 14a-14d of the lower plank 14, respectively, and two spring assemblies 16e and 16f of the plurality of spring assemblies are disposed closer to a center 14e of the lower plank 14. This configuration (e.g., the number, positioning, spring rates) of the six spring assemblies are configured to decrease vibration for transporting a baby secured on the upper plank 12, where the baby is about two pounds.

As another non-limiting example, as shown in FIG. 9, the plurality of spring assemblies 16 of a vibration reduction device 10 includes seven spring assemblies 16g-16m, where each spring assembly of the plurality of spring assemblies provides a spring rate ranging from about 1 to about 2 pounds/inch. As shown, four spring assemblies 16g-16j of the plurality of spring assemblies are disposed at four corners 14a-14d of the lower plank 14, respectively, and three spring assemblies 16k-16m of the plurality of spring assemblies are disposed closer to a center 14e of the lower plank 14. This configuration (e.g., the number, positioning, spring rates) of the seven spring assemblies are configured to decrease vibration for transporting a baby secured on the upper plank 12, where the baby is about four pounds.

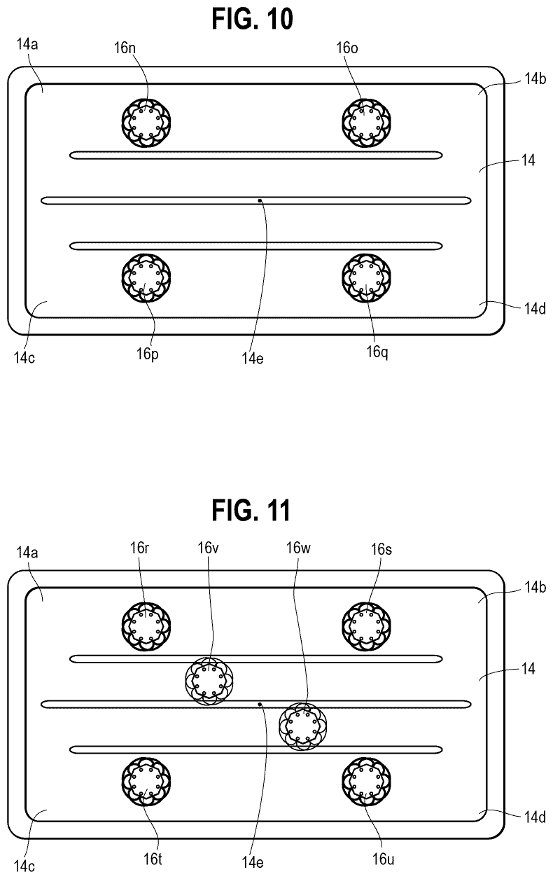

As another non-limiting example, as shown in FIG. 10, the plurality of spring assemblies 16 of a vibration reduction device 10 includes four spring assemblies 16n-16q, where each spring assembly of the plurality of spring assemblies provides a spring rate ranging from about 5 to about 6 pounds/inch. As shown, the four spring assemblies 16n-16q are disposed closer to four corners 14a-14d of the lower plank 14, respectively. This configuration (e.g., the number, positioning, spring rates) of the four spring assemblies are configured to decrease vibration for transporting a baby secured on the upper plank 12, where the baby is about six pounds.

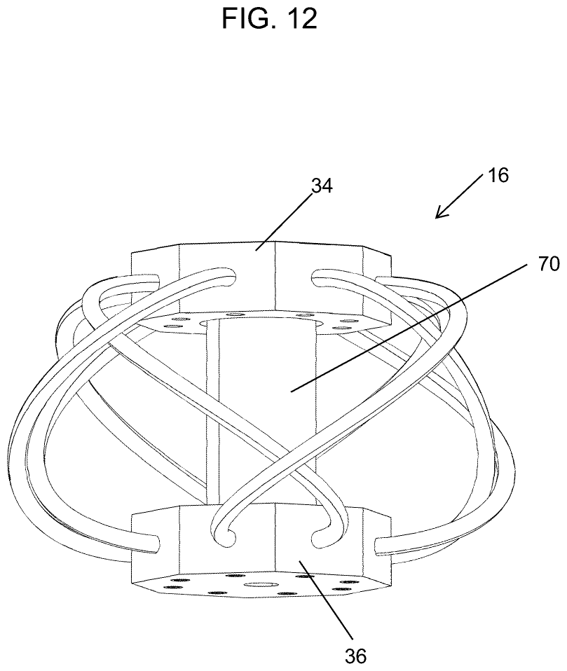

As another non-limiting example, as shown in FIG. 11, the plurality of spring assemblies 16 includes six spring assemblies 16r-16w, where four spring assemblies 16r-16u of the plurality of spring assemblies each provides a spring rate ranging from about 5 to about 6 pounds/inch, and where two spring assemblies 16v-16w of the plurality of spring assemblies each provides a spring rate ranging from about 1 to about 2 pounds/inch. As shown, the four spring assemblies 16r-16u are disposed closer to four corners 14a-14d of the lower plank 14, respectively, and the two spring assemblies 16v and 16w are disposed closer to a center 14e of the lower plank 14. This configuration (e.g., the number, positioning, spring rates) of the six spring assemblies are configured to decrease vibration for transporting a baby secured on the upper plank 12, where the baby is about eight pounds.

In some embodiments, as shown in FIGS. 12-16, the wire rope isolator 16 may include at least one cushion component 70 disposed between the first end portion 34 and the second end portion 36 of the wire rope isolator 16. The at least one cushion component 70 is configured such that even in a maximum force impact, the first end portion 34 and the second end portion 36 do not hit one another, thereby preventing them from causing extra recoil and/or vibrations from the force impact. In some embodiments, the at least one cushion component 70 may be configured to absorb different vibration frequencies and/or high impacts that exceed the dampening threshold of the wire segments of the wire rope isolator 16.

Referring to FIGS. 12-14, in some embodiments, the wire rope isolator 16 may include a cushion component 70 extending between the first end portion 34 and the second end portion 36. The cushion component 70 may have a tubular configuration. The first end portion 34 may include a first opening 74 configured for receiving at least a portion (e.g., a first end portion) of the cushion component 70, and the second end portion 36 may include a second opening 72 configured for receiving at least another portion (e.g., a second end portion, opposite the first end portion) of the cushion component 70.

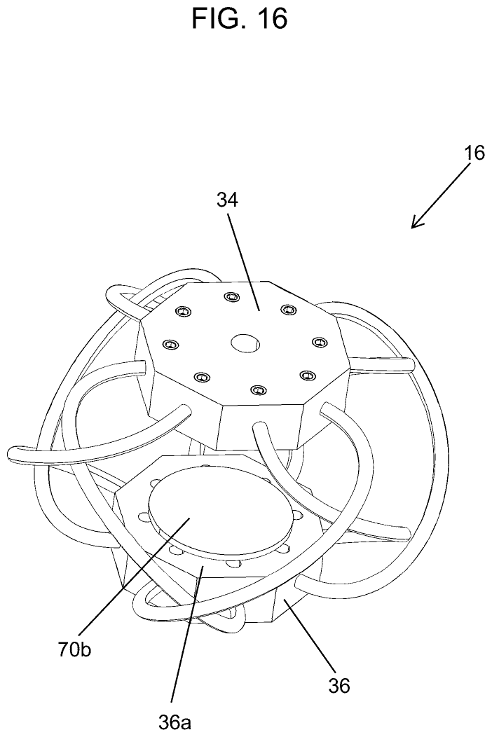

Referring to FIGS. 15 and 16, in some embodiments, the wire rope isolator 16 may include a first cushion component 70a disposed at a first surface 34a of the first end portion 34 and a second cushion component 70b disposed at a first surface 36a of the second end portion 36. The first cushion component 70a and the second cushion component 70b are configured to at least partially contact one another when the first end portion 34 and the second end portion 36 move towards one another, such that the first surface 34a and the first surface 36a do not contact one another even in a maximum force impact. As shown in FIGS. 15 and 16, the first cushion component 70a and the second cushion component 70b both have the same circular configuration and the same thickness, and they may entirely contact one another when the first end portion 34 and the second end portion 36 move towards one another. It will be understood that in some embodiments, the first cushion component 70a and the second cushion component 70b may have different configurations (e.g., different shapes, sizes, and thicknesses) without departing from the scope of the present disclosure. In some embodiments, the cushion component may be disposed only at the first end portion 34 or the second end portion 36.

The cushion component(s) may be made of any suitable material (e.g., foam), as long as it provides cushion when the first end portion 34 and the second end portion move towards one another. The number, material, and configuration (e.g., size, shape) of the cushion component(s) may be varied, as desired and/or needed, to achieve desired dampening properties, without departing from the scope of the present disclosure.

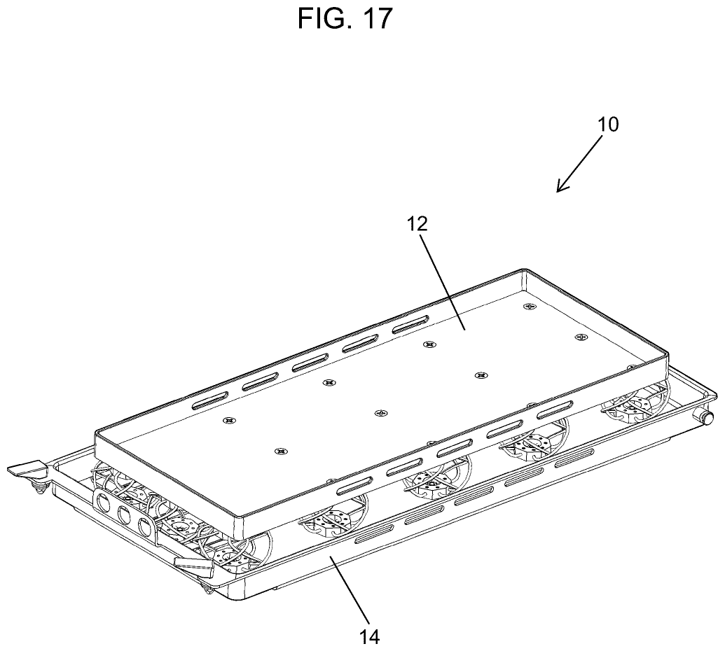

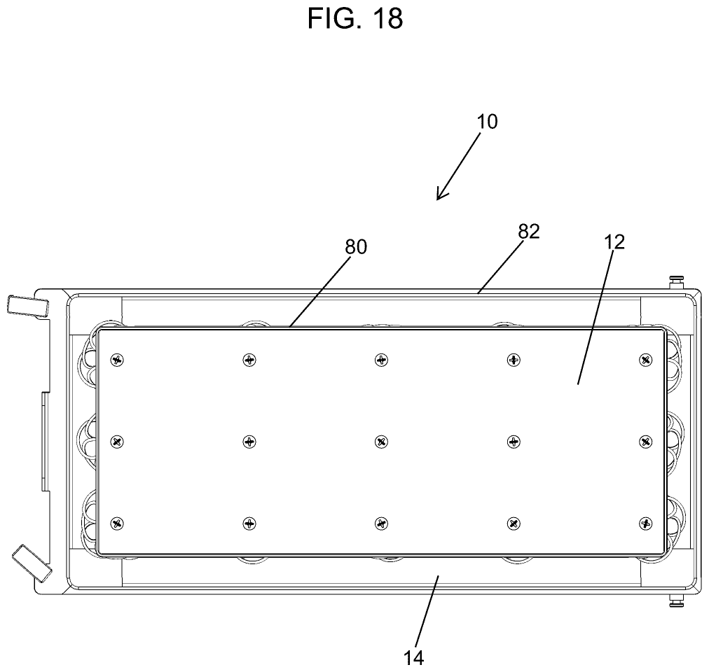

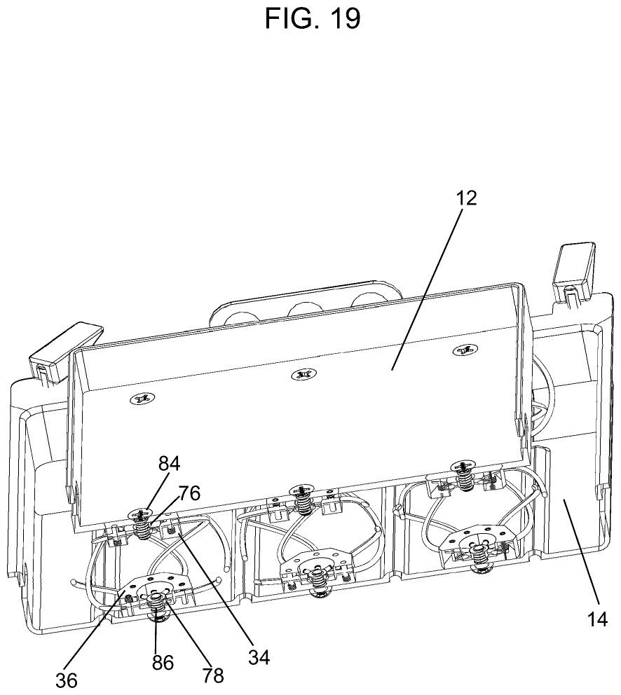

The wire rope isolator 16 is able to shift translationally (such as dampening for a wide turn on the road), and due to this, there may be potential interference between the upper plank 12 and the lower plank 14 if there was translational motion paired with up and down. To mitigate this, in some embodiments, the upper plank 12 may be smaller than the lower plank 14 (e.g., by a margin) such that interference/clashing of the upper and lower planks 12 and 14 is avoided in any worst case scenario. Referring to FIGS. 17-19, in some embodiments, the upper plank 12 may have a smaller dimension than the lower plank 14, such that vibration of the device 10 will not cause the upper plank 12 to hit the lower plank 14. For example, as shown in FIG. 18, the entire perimeter 80 of the upper plank 12 is spaced apart from the entire perimeter 82 of the lower plank 14, when viewed from the top of the device 10.

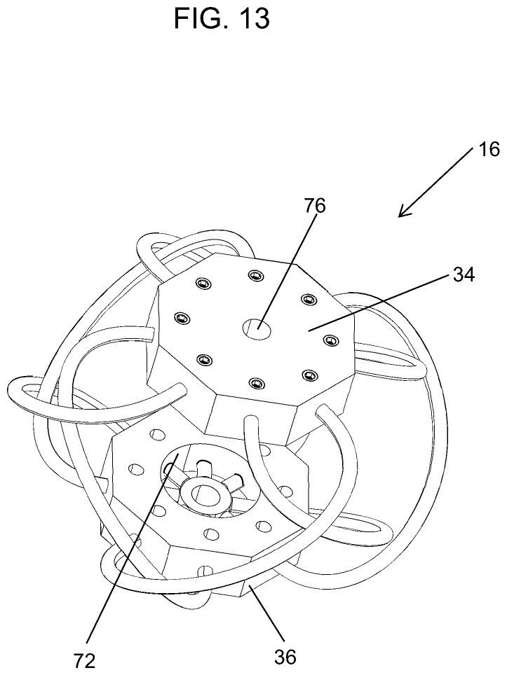

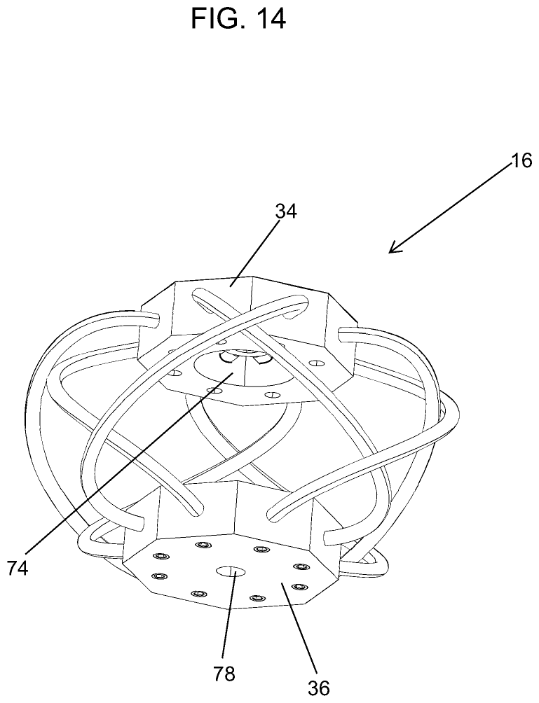

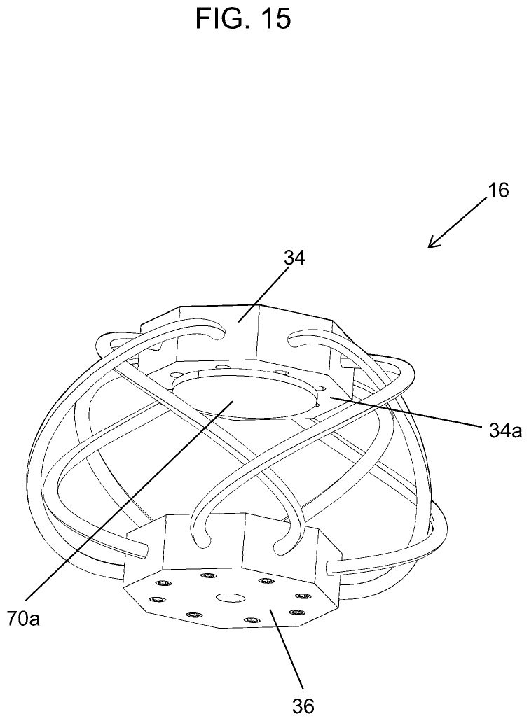

In some embodiments, as shown in FIGS. 13, 14, and 19, the first end portion 34 of the wire rope isolator 16 may include a first hole 76 and the second end portion 36 of the wire rope isolator 16 may include a second hole 78. The first hole 76 and the second hole 78 are configured to receive fasteners such that the wire rope isolator 16 may be secured to the upper plank 12 and/or the lower plank 14 via fasteners (e.g., screws). For example, as shown in FIG. 19, the first end portion 34 is secured to the upper plank 12 via the first screw 84 at least partially received in the first hole 76, and the second end portion 36 is secured to the lower plank 14 via the second screw 86 at least partially received in the second hole 78.

A first aspect relates to a wire rope isolator, comprising: a first end portion; a second end portion, wherein the first end portion and the second end portion substantially overlap each other in a first axis and are spaced apart from each other in the first axis; and a plurality of wire segments extending between the first end portion and the second end portion, wherein each wire segment includes a first end extending out of the first end portion and a second end extending out of the second end portion, wherein each wire segment of the plurality of wire segments crosses over at least one other wire segment of the plurality of wire segments to form a first X-shaped configuration when viewed from a point in a first plane.

A second aspect relates to the wire rope isolator of aspect 1, wherein each wire segment of the plurality of wire segments crosses over at least two other wire segments of the plurality of wire segments to form the first X-shaped configuration and a second X-shaped configuration when viewed from a point in the first plane.

A third aspect relates to the wire rope isolator of aspect 1 or aspect 2, wherein the first X-shaped configuration is closer to the first end portion than the second X-shaped configuration, and wherein the second X-shaped configuration is closer to the second end portion than the first X-shaped configuration.

A fourth aspect relates to the wire rope isolator of any preceding aspect, wherein the first end portion includes a plurality of upper side facets and the second end portion includes a plurality of lower side facets, wherein each upper side facet of the plurality of upper side facets includes a first end of a wire segment extending out of the respective upper side facet in a direction substantially vertical with respect to the respective upper side facet.

A fifth aspect relates to the wire rope isolator of any preceding aspect, wherein each lower side facet of the plurality of lower side facets includes a second end of a wire segment extending out of the respective lower side facet in a direction substantially vertical with respect to the respective lower side facet.

A sixth aspect relates to the wire rope isolator of any preceding aspect, wherein the wire rope isolator provides a spring rate ranging from about 1 to about 2 pounds/inch, ranging from about 5 to about 6 pounds/inch, or ranging from about 11 to about 12 pounds/inch.

A seventh aspect relates to the wire rope isolator of any preceding aspect, wherein each wire segment of the plurality of wire segments has a diameter ranging between about 1 mm and about 6 mm.

An eighth aspect relates to the wire rope isolator of any preceding aspect, further comprising at least one cushion component disposed between the first end portion and the second end portion.

A ninth aspect relates to the wire rope isolator of any preceding aspect, further comprising at least one set screw in the first end portion and the second end portion to hold ends of the plurality of wire segments within the first end portion and the second end portion.

A tenth aspect relates to a device for providing neonatal transport vibration reduction, comprising: an upper plank configured to support a neonatal mattress; a lower plank configured to couple to a neonatal isolette; and a plurality of spring assemblies disposed between the upper plank and the lower plank, wherein each spring assembly of the plurality of spring assemblies provides a substantially uniform spring rate in a plurality of directions in a first plane that is substantially horizontal to the upper plank and the lower plank.

An eleventh aspect relates to the device of aspect 10, wherein the plurality of spring assemblies is configured to decrease vibration for transporting a baby secured on the upper plank.

A twelfth aspect relates to the device of aspect 10 or aspect 11, wherein each spring assembly of the plurality of spring assemblies includes a plurality of wire segments, and wherein each wire segment of the plurality of wire segments crosses over at least one other wire segment of the plurality of wire segments to form a first X-shaped configuration when viewed from a point in the first plane.

A thirteenth aspect relates to the device of any one of aspects 10-12, further comprising a strap assembly configured to secure a baby on the upper plank.

A fourteenth aspect relates to the device of any one of aspects 10-13, further comprising a vibration-reduction layer disposed underneath the lower plank.

A fifteenth aspect relates to the device of any one of aspects 10-14, wherein the upper plank has a smaller dimension than the lower plank.

A sixteenth aspect relates to a device for providing neonatal transport vibration reduction, comprising: an upper plank; a lower plank; and a plurality of spring assemblies disposed between the upper plank and the lower plank, wherein the upper plank includes a strap assembly configured to secure a baby on the upper plank, and wherein the lower plank is configured to releasably couple to a neonatal isolette.

A seventeenth aspect relates to the device of aspect 16, wherein the plurality of spring assemblies includes six spring assemblies, and wherein each spring assembly of the plurality of spring assemblies provides a spring rate ranging from about 1 to about 2 pounds/inch.

An eighteenth aspect relates to the device of aspect 16 or aspect 17, wherein the plurality of spring assemblies includes seven spring assemblies, and wherein each spring assembly of the plurality of spring assemblies provides a spring rate ranging from about 1 to about 2 pounds/inch.

A nineteenth aspect relates to the device of any one of aspects 16-18, wherein the plurality of spring assemblies includes four spring assemblies, and wherein each spring assembly of the plurality of spring assemblies provides a spring rate ranging from about 5 to about 6 pounds/inch.

A twentieth aspect relates to the device of any one of aspects 16-19, wherein the plurality of spring assemblies includes six spring assemblies, wherein four spring assemblies of the plurality of spring assemblies each provides a spring rate ranging from about 5 to about 6 pounds/inch, and wherein two spring assemblies of the plurality of spring assemblies each provides a spring rate ranging from about 1 to about 2 pounds/inch.

Those of skill in the art will appreciate that embodiments not expressly illustrated herein may be practiced within the scope of the claims, including that features described herein for different embodiments may be combined with each other and/or with currently-known or future-developed technologies while remaining within the scope of the claims. Although specific terms are employed herein, they are used in a generic and descriptive sense only and not for purposes of limitation unless specifically defined by context, usage, or other explicit designation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment. In the event of any inconsistent disclosure or definition from the present application conflicting with any document incorporated by reference, the disclosure or definition herein shall be deemed to prevail.

The invention claimed is:

1. A wire rope isolator, comprising:
a first end portion;
a second end portion, wherein the first end portion and the second end portion substantially overlap each other in a first axis and are spaced apart from each other in the first axis; and
a plurality of wire segments extending between the first end portion and the second end portion, wherein each wire segment includes a first end extending out of the first end portion and a second end extending out of the second end portion,
wherein each wire segment of the plurality of wire segments crosses over at least one other wire segment of the plurality of wire segments to form a first X-shaped configuration when viewed from a point in a first plane.

2. The wire rope isolator of claim 1, wherein each wire segment of the plurality of wire segments crosses over at least two other wire segments of the plurality of wire segments to form the first X-shaped configuration and a second X-shaped configuration when viewed from a point in the first plane.

3. The wire rope isolator of claim 2, wherein the first X-shaped configuration is closer to the first end portion than the second X-shaped configuration, and wherein the second X-shaped configuration is closer to the second end portion than the first X-shaped configuration.

4. The wire rope isolator of claim 1, wherein the first end portion includes a plurality of upper side facets and the second end portion includes a plurality of lower side facets, wherein each upper side facet of the plurality of upper side facets includes a first end of a wire segment extending out of the respective upper side facet in a direction substantially vertical with respect to the respective upper side facet.

5. The wire rope isolator of claim 4, wherein each lower side facet of the plurality of lower side facets includes a second end of a wire segment extending out of the respective lower side facet in a direction substantially vertical with respect to the respective lower side facet.

6. The wire rope isolator of claim 1, wherein the wire rope isolator provides a spring rate ranging from about 1 to about 2 pounds/inch, ranging from about 5 to about 6 pounds/inch, or ranging from about 11 to about 12 pounds/inch.

7. The wire rope isolator of claim 1, wherein each wire segment of the plurality of wire segments has a diameter ranging between about 1 mm and about 6 mm.

8. The wire rope isolator of claim 1, further comprising at least one cushion component disposed between the first end portion and the second end portion.

9. The wire rope isolator of claim 1, further comprising at least one set screw in the first end portion and the second end portion to hold ends of the plurality of wire segments within the first end portion and the second end portion.

10. A device for providing neonatal transport vibration reduction, comprising:
an upper plank configured to support a neonatal mattress;
a lower plank configured to couple to a neonatal isolette; and
a plurality of spring assemblies disposed between the upper plank and the lower plank,
wherein each spring assembly of the plurality of spring assemblies provides a substantially uniform spring rate in a plurality of directions in a first plane that is substantially horizontal to the upper plank and the lower plank.

11. The device of claim 10, wherein the plurality of spring assemblies is configured to decrease vibration for transporting a baby secured on the upper plank.

12. The device of claim 10, wherein each spring assembly of the plurality of spring assemblies includes a plurality of wire segments, and wherein each wire segment of the plurality of wire segments crosses over at least one other wire segment of the plurality of wire segments to form a first X-shaped configuration when viewed from a point in the first plane.

13. The device of claim 10, further comprising a strap assembly configured to secure a baby on the upper plank.

14. The device of claim 10, further comprising a vibration-reduction layer disposed underneath the lower plank.

15. The device of claim 10, wherein the upper plank has a smaller dimension than the lower plank.

16. A device for providing neonatal transport vibration reduction, comprising:
an upper plank;
a lower plank; and
a plurality of spring assemblies disposed between the upper plank and the lower plank,
wherein the upper plank includes a strap assembly configured to secure a baby on the upper plank, and
wherein the lower plank is configured to releasably couple to a neonatal isolette.

17. The device of claim 16, wherein the plurality of spring assemblies includes six spring assemblies, and wherein each spring assembly of the plurality of spring assemblies provides a spring rate ranging from about 1 to about 2 pounds/inch.

18. The device of claim 16, wherein the plurality of spring assemblies includes seven spring assemblies, and wherein each spring assembly of the plurality of spring assemblies provides a spring rate ranging from about 1 to about 2 pounds/inch.

19. The device of claim 16, wherein the plurality of spring assemblies includes four spring assemblies, and wherein each spring assembly of the plurality of spring assemblies provides a spring rate ranging from about 5 to about 6 pounds/inch.

20. The device of claim 16, wherein the plurality of spring assemblies includes six spring assemblies, wherein four spring assemblies of the plurality of spring assemblies each provides a spring rate ranging from about 5 to about 6 pounds/inch, and wherein two spring assemblies of the plurality of spring assemblies each provides a spring rate ranging from about 1 to about 2 pounds/inch.
